(19) United States
(12) Patent Application Publication
(10) Pub. No.: US 2026/0170592 A1
(43) Pub. Date: Jun. 18, 2026

(54) Identification of Accelerator Location

(71) Applicant: ATI Technologies ULC, Markham (CA)

(72) Inventor: Ting-Yu Lin, Vaughan (CA)

(73) Assignee: ATI Technologies ULC, Markham (CA)

(21) Appl. No.: 18/984,729

(22) Filed: Dec. 17, 2024

(51) Int. Cl. G06T 1/20

(52) U.S. Cl. CPC G06T 1/20

(57) ABSTRACT

Systems and techniques for identifying accelerator locations are described. Accelerator units are enumerated with index identifiers embedded with the unit’s physical location to improve the identification and servicing of accelerators in data centers. In one example, a computing device (e.g., a server in a data center) includes multiple accelerator units (e.g., graphics processing units (GPUs)) positioned in a physical configuration. For example, the GPUs are arranged in a two-dimensional (2D) grid. Indexer circuitry enumerates each accelerator unit with an index identifier indicating the unit’s physical location within the configuration. In this way, the described techniques indicate to technicians the location of one or more accelerator units to be serviced, troubleshooted, or replaced without referencing system schematics or other materials, thus improving service times drastically.

### BACKGROUND

Many data centers use multiple accelerators, such as graphics processing units (GPUs), to increase processing capabilities and support resource-intensive applications like machine learning. Some data centers implement the Open Compute Project (OCP) Accelerator Module (OAM) specification, which sets a standard form factor and electrical interface for accelerators in a server chassis. Servers are designed to accommodate multiple OAM modules on a universal baseboard, allowing data centers to easily scale processing power by adding more units as necessary. This modular design also facilitates simpler upgrades and replacements without requiring a complete overhaul of the server system. However, the lack of standardized indexing or enumeration makes it challenging and time-consuming for technicians to identify, repair, or replace faulty accelerators.

### BRIEF DESCRIPTION OF THE DRAWINGS

FIG. 1A is a block diagram of a processing system configured to execute one or more applications in accordance with one or more implementations.

FIG. 1B is a block diagram of a non-limiting example system having a device that implements indexing techniques to identify accelerator locations.

FIG. 2 is a block diagram of a non-limiting example procedure that illustrates a stepwise algorithm for identifying the location of accelerator units.

### DETAILED DESCRIPTION

The increased presence and use of machine-learning models and other artificial intelligence applications have increased the processing requirements of data centers. To address this need, data centers have added more and more accelerators, including GPUs, neural network engines (NNEs), neural processing units (NPUs), accelerated processing units (APUs), inference processing units (IPUs), vision processing units (VPUs), digital signal processors (DSPs), and field-programmable gate arrays (FPGAs), into server systems.

Some data centers follow the OAM specification to design servers to accommodate multiple OAM accelerators. Because the OAM specification defines a standard form factor and electrical interface for accelerator units, data centers can easily scale processing power by adding more units as necessary. This universal format also lowers costs for data centers by simplifying the upgrading and replacing of specific accelerators. For example, technicians can swap or troubleshoot specific accelerators without altering the server system.

In data centers, the accelerator units are often mounted on the universal baseboard in a grid (e.g., eight GPUs in a four-by-two or two-by-four grid). There is no standardized indexing or enumeration scheme for accelerator units within the OAM specification or other industry standards. The lack of a standard location designation for accelerators makes it challenging and time-consuming for technicians to identify, repair, or replace faulty units. Accelerator units are generally given serial index identifiers (e.g., by an operating system) that do not convey or include any relationship to the unit’s physical location on the baseboard. As a result, technicians must consult confusing schematics or PCI configuration data to identify the faulty unit.

In contrast, the described systems and techniques for identifying accelerator locations provide a standardized indexing scheme that indicates a unit’s location within the physical server. The location of an accelerator unit is mapped to a two-dimensional (2D) or three-dimensional (3D) grid, which is embedded in its index identifier. In this way, the index identifier makes it (instantly) clear to technicians where the accelerator-under-service is located on the baseboard. As a result, the time to service faulty unit is drastically.

In one example scenario, eight GPUs are placed in a two-by-four grid on a universal baseboard. The GPU index is defined to use a left-to-right and top-to-bottom ordering to create a Cartesian-like coordinate system (e.g., x and y axes). In other implementations, a radial coordinate system is used for GPUs arranged in one or more rings. In yet other implementations, a 3D coordinate system is used for 3D stacked GPUs. The coordinate system is then used to dynamically assign a GPU index to each GPU based on its location in the grid. For example, GPU indexed as “102” indicates that the GPU module is in the first row and second column. If GPU 102 needs service, the technician quickly locates and services the unit.

In some aspects, the techniques and systems described herein relate to a system comprising multiple accelerator units positioned in a physical configuration and indexer circuitry configured to enumerate each accelerator unit of the multiple accelerator units with an index number that indicates a physical location of the accelerator unit within the physical configuration.

In some aspects, the techniques and systems described herein relate to a system wherein the accelerator unit comprises a graphics processing unit (GPU), neural network engine (NNE), neural processing unit (NPU), inference processing unit (IPU), accelerated processing unit (APU), vision processing unit (VPU), digital signal processor (DSP), or field-programmable gate array (FPGA).

In some aspects, the techniques and systems described herein relate to a system wherein the physical configuration is a two-dimensional (2D) rectangle, and the index number indicates a horizontal position and a vertical position of the accelerator unit within the 2D rectangle.

In some aspects, the techniques and systems described herein relate to a system wherein the physical configuration is a three-dimensional (3D) cuboid, and the index number indicates a horizontal position, a vertical position, and a depth position of the accelerator unit within the 3D cuboid.

In some aspects, the techniques and systems described herein relate to a system wherein the physical configuration is a two-dimensional (2D) circle, and the index number indicates an angular position of the accelerator unit within the 2D circle.

In some aspects, the techniques and systems described herein relate to a system comprising a server of multiple servers within a data center.

In some aspects, the techniques and systems described herein relate to a system wherein the multiple accelerator units are mounted on a universal baseboard according to an Open Compute Project (OCP) Accelerator Module (OAM) specification.

In some aspects, the techniques and systems described herein relate to a system wherein the universal baseboard includes markings corresponding to the index number of each accelerator unit.

In some aspects, the techniques and systems described herein relate to a system wherein the indexer circuitry includes software or firmware in a basic input/output system (BIOS) of the multiple accelerator units, an operating system of the system, or a hypervisor of the system.

In some aspects, the techniques and systems described herein relate to a system wherein the index number is provided as a value in base-two, base-ten, or base-16 format.

In some aspects, the techniques and systems described herein relate to a method comprising enumerating, by indexer circuitry, each accelerator unit of multiple accelerator units in a computing device with an index identifier indicating a physical location of each accelerator unit within the computing device and outputting the index number of a first accelerator unit of the multiple accelerator units to be serviced.

In some aspects, the techniques and systems described herein relate to a method wherein the computing device comprises a server.

In some aspects, the techniques and systems described herein relate to a method wherein the index identifier is provided in a coordinate system corresponding to a physical configuration of the multiple accelerator units in the computing device.

In some aspects, the techniques and systems described herein relate to a method wherein the multiple accelerator units are mounted on a baseboard or chassis according to a known specification.

In some aspects, the techniques and systems described herein relate to a method wherein the indexer circuitry includes a basic input/output system (BIOS) of each accelerator unit, an operating system of the computing device, or a hypervisor of the computing device.

In some aspects, the techniques and systems described herein relate to a method wherein the index identifier is provided as a value in base-two, base-ten, or base-16 format.

In some aspects, the techniques and systems described herein relate to an accelerator unit comprising indexer circuitry configured to enumerate the accelerator unit with an index identifier that indicates a physical location of the accelerator unit within a physical configuration of multiple accelerator units on a baseboard.

In some aspects, the techniques and systems described herein relate to an accelerator unit wherein the indexer circuitry includes a video basic input/output system (VBIOS) of the accelerator unit.

In some aspects, the techniques and systems described herein relate to an accelerator unit wherein the accelerator unit comprises a graphics processing unit (GPU), neural network engine (NNE), neural processing unit (NPU), inference processing unit (IPU), accelerated processing unit (APU), vision processing unit (VPU), digital signal processor (DSP), or field-programmable gate array (FPGA).

In some aspects, the techniques and systems described herein relate to an accelerator unit wherein the index identifier is provided in a coordinate system corresponding to the physical configuration of the multiple accelerator units in a computing device.

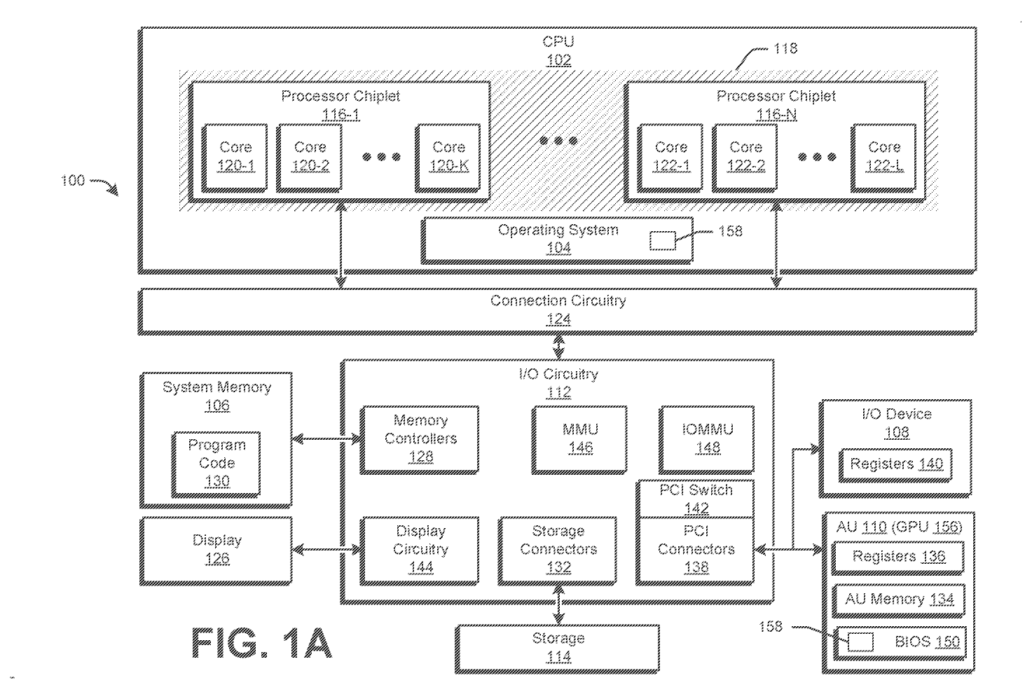

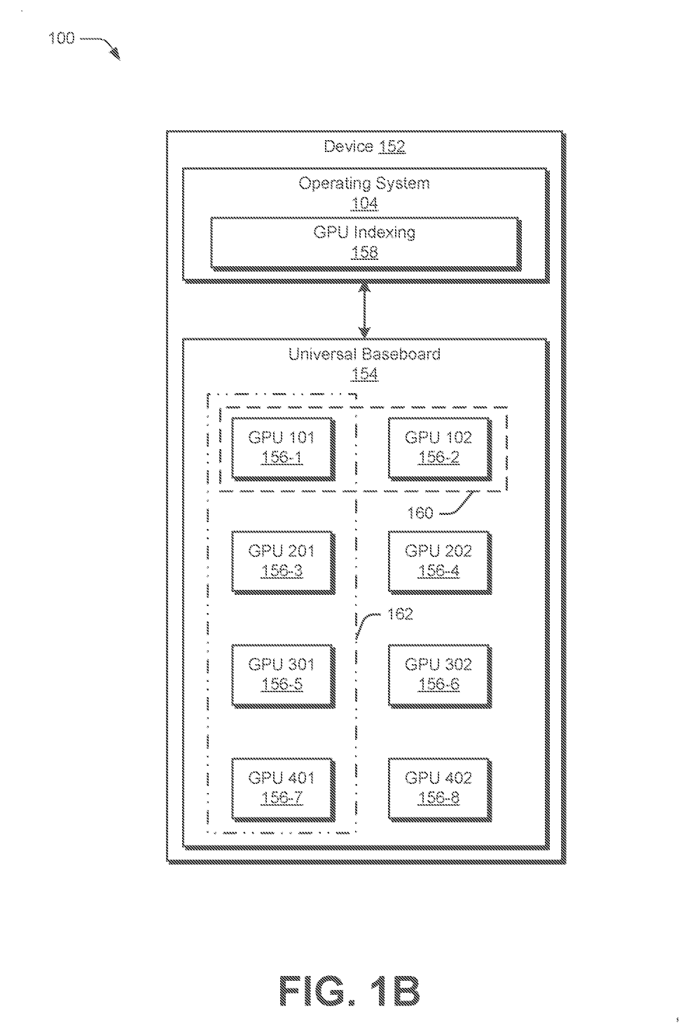

FIG. 1A is a block diagram of a processing system configured to execute one or more applications in accordance with one or more implementations. In particular, FIG. 1A includes an example processing system 100 configured to execute one or more applications, such as computing applications (e.g., machine-learning applications, neural network applications, high-performance computing applications, databasing applications, gaming applications), graphics applications, and the like. Examples of devices (e.g., the device 152 of FIG. 1B) in which the processing system 100 is implemented include but are not limited to a server, personal computer (e.g., desktop or tower computer), notebook computer, automotive computer, and other computing devices or systems.

In the illustrated example, the processing system 100 includes a central processing unit (CPU) 102. In one or more implementations, the CPU 102 is configured to run an operating system (OS) 104 that manages the execution of applications. For example, the OS 104 is configured to schedule the execution of tasks (e.g., instructions) for applications, allocate portions of resources (e.g., system memory 106, CPU 102, input/output (I/O) device 108, accelerator unit (AU) 110, storage 114) for the execution of tasks for the applications, provide an interface to I/O devices (e.g., I/O device 108) for the applications, or any combination thereof.

In this example, the OS 104 with GPU indexing 158 (which is described in greater detail with respect to FIG. 1B) is depicted as part of the CPU 102. In addition, GPUs 156 are depicted as examples of the AU 110. In other implementations, the GPU indexing 158 is included in and/or is implemented by one or more different components of the processing system 100, such as the CPU 102, connection circuitry 124, or I/O circuitry 112.

The CPU 102 includes one or more processor chiplets 116, which are communicatively coupled by a data fabric 118 in one or more implementations. Each processor chiplet 116, for example, includes one or more processor cores 120, 122 configured to execute one or more series of instructions concurrently, also referred to herein as “threads”, for an application. Further, the data fabric 118 communicatively couples each processor chiplet 116-N of the CPU 102 such that each processor core (e.g., processor cores 120) of a first processor chiplet (e.g., 116-1) is communicatively coupled to each processor core (e.g., processor cores 122) of one or more other processor chiplets 116.

Though the example embodiment in FIG. 1A shows a first processor chiplet (116-1) having three processor cores (120-1, 120-2, 120-K) representing a K number of processor cores 122 and a second processor chiplet (116-N) having three processor cores (e.g., 122-1, 122-2, 122-L) representing an L number of processor cores 122, in other implementations (L being an integer number greater than or equal to one), each processor chiplet 116 may have any number of processor cores 120, 122. For example, each processor chiplet 116 can have the same number of processor cores 120, 122 as one or more other processor chiplets 116, a different number of processor cores 120, 122 as one or more other processor chiplets 116, or both.

Examples of connections that are usable to implement the data fabric 118 include but are not limited to buses (e.g., a data bus, a system, an address bus), interconnects, memory channels, and silicon vias, traces, and planes. Other example connections include optical connections, fiber optic connections, and/or connections or links based on quantum entanglement.

Additionally, within the processing system 100, the CPU 102 is communicatively coupled to an I/O circuitry 112 by a connection circuitry 124. For example, each processor chiplet 116 of the CPU 102 is communicatively coupled to the I/O circuitry 112 by the connection circuitry 124. The connection circuitry 124 includes, for example, one or more data fabrics, buses, buffers, queues, and the like. The I/O circuitry 112 is configured to facilitate communications between two or more components of the processing system 100 such as between the CPU 102, system memory 106, display 126, universal serial bus (USB) devices, peripheral component interconnect (PCI) devices (e.g., I/O device 108, AU 110), storage 114, and the like.

As an example, system memory 106 includes any combination of one or more volatile memories and/or one or more non-volatile memories, examples of which include dynamic random-access memory (DRAM), static random-access memory (SRAM), non-volatile RAM, and the like. To manage access to the system memory 106 by CPU 102, the I/O device 108, the AU 110, and/or any other components, the I/O circuitry 112 includes one or more memory controllers 128. The memory controllers 128, for example, include circuitry configured to manage and fulfill memory access requests issued from the CPU 102, the I/O device 108, the AU 110, or any combination thereof. Examples of such requests include read requests, write requests, fetch requests, pre-fetch requests, or any combination thereof. That is to say, the memory controllers 128 are configured to manage access to the data stored at one or more memory addresses within the system memory 106, such as by CPU 102, I/O device 108, and/or AU 110.

When an application is to be executed by processing system 100, the OS 104 running on the CPU 102 is configured to load at least a portion of program code 130 (e.g., an executable file) associated with the application from, for example, a storage 114 into system memory 106. This storage 114, for example, includes a non-volatile storage such as a flash memory, solid-state memory, hard disk, optical disc, or the like configured to store program code 130 for one or more applications.

To facilitate communication between the storage 114 and other components of processing system 100, the I/O circuitry 112 includes one or more storage connectors 132 (e.g., universal serial bus (USB) connectors, serial AT attachment (SATA) connectors, PCI Express (PCIe) connectors) configured to communicatively couple storage 114 to the I/O circuitry 112 such that I/O circuitry 112 is capable of routing signals to and from the storage 114 to one or more other components of the processing system 100.

In association with executing an application, in one or more scenarios, the CPU 102 is configured to issue one or more instructions (e.g., threads) to be executed for an application to the AU 110. The AU 110 is configured to execute these instructions by operating as one or more vector processors, coprocessors, graphics processing units (GPUs) such as GPUs 156 of FIG. 1B mounted on a universal baseboard 154, general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 110 includes one or more compute units that concurrently execute one or more threads of an application and store data resulting from the execution of these threads in AU memory 134. This AU memory 134, for example, includes any combination of one or more volatile memories and/or non-volatile memories, examples of which include caches, video RAM (VRAM), or the like. In one or more implementations, these compute units are also configured to execute these threads based on the data stored in one or more physical registers 136 of the AU 110.

To facilitate communication between the AU 110 and one or more other components of processing system 100, the I/O circuitry 112 includes or is otherwise connected to one or more connectors, such as PCI connectors 138 (e.g., PCIe connectors) each including circuitry configured to communicatively couple the AU 110 to the I/O circuitry such that the I/O circuitry 112 is capable of routing signals to and from the AU 110 to one or more other components of the processing system 100. Further, the PCIe connectors 138 are configured to communicatively couple the I/O device 108 to the I/O circuitry 112 such that the I/O circuitry 112 is capable of routing signals to and from the I/O device 108 to one or more other components of the processing system 100.

The AU 110 also includes basic input/output system (BIOS) 150 used during startup or the boot process to initialize the AU 110 and prepare for interaction with the operating system (e.g., operating system 104 of FIGS. 1A and 1B). During bootup, the BIOS 150 performs a series of checks and configurations, including power management setup, memory initialization, and clock speed calibration. The BIOS 150 is generally firmware in the AU 110 and stores information about the specific AU 110. For example, the BIOS 150 stores GPU indexing 158 (which is described in greater detail with respect to FIG. 1B) to identify the physical location of AU 110 within a server or on a universal baseboard. In some implementations, the hardware identifying information also includes the manufacturer and model number of AU 110. In this example, the GPU indexing 158 is depicted as implemented in the the BIOS 150 and/or the operating system 104.

By way of example and not limitation, the I/O device 108 includes one or more camera systems, keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 108 is configured to execute one or more operations, tasks, instructions, or any combination thereof based on one or more physical registers 140 of the I/O device 108. In one or more implementations, such physical registers 140 are configured to maintain data (e.g., operands, instructions, values, variables) indicating one or more operations, tasks, or instructions to be performed by the I/O device 108.

To manage communication between components of the processing system 100 (e.g., AU 110, I/O device 108) that are connected to PCI connectors 138, and one or more other components of the processing system 100, the I/O circuitry 112 includes PCI switch 142. The PCI switch 142, for example, includes circuitry configured to route packets to and from the components of the processing system 100 connected to the PCI connectors 138 as well as to the other components of the processing system 100. As an example, based on address data indicated in a packet received from a first component (e.g., CPU 102), the PCI switch 142 routes the packet to a corresponding component (e.g., AU 110) connected to the PCI connectors 138.

Based on the processing system 100 executing a graphics application, for instance, the CPU 102, the AU 110, or both are configured to execute one or more instructions (e.g., draw calls) such that a scene including one or more graphics objects is rendered. After rendering such a scene, the processing system 100 stores the scene in the storage 114, displays the scene on the display 126, or both. The display 126, for example, includes a cathode-ray tube (CRT) display, liquid crystal display (LCD), light emitting diode (LED) display, organic light emitting diode (OLED) display, or any combination thereof. To enable the processing system 100 to display a scene on the display 126, the I/O circuitry 112 includes display circuitry 144. The display circuitry 144, for example, includes high-definition multimedia interface (HDMI) connectors, DisplayPort connectors, digital visual interface (DVI) connectors, USB connectors, and the like, each including circuitry configured to communicatively couple the display 126 to the I/O circuitry 112. Additionally or alternatively, the display circuitry 144 includes circuitry configured to manage the display of one or more scenes on the display 126 such as display controllers, buffers, memory, or any combination thereof.

Further, the CPU 102, the AU 110, or both are configured to concurrently run one or more virtual machines (VMs), which are each configured to execute one or more corresponding applications. To manage communications between such VMs and the underlying resources of the processing system 100, such as any one or more components of processing system 100, including the CPU 102, the I/O device 108, the AU 110, and the system memory 106, the I/O circuitry 112 includes memory management unit (MMU) 146 and input-output memory management unit (IOMMU) 148. The MMU 146 includes, for example, circuitry configured to manage memory requests, such as from the CPU 102 to the system memory 106. For example, the MMU 146 is configured to handle memory requests issued from the CPU 102 and associated with a VM running on the CPU 102. These memory requests, for example, request access to read, write, fetch, or pre-fetch data residing at one or more virtual addresses (e.g., guest virtual addresses) each indicating one or more portions (e.g., physical memory addresses) of the system memory 106. Based on receiving a memory request from the CPU 102, the MMU 146 is configured to translate the virtual address indicated in the memory request to a physical address in the system memory 106 and to fulfill the request. The IOMMU 148 includes, for example, circuitry configured to manage memory requests (memory-mapped I/O (MMIO) requests) from the CPU 102 to the I/O device 108, the AU 110, or both, and to manage memory requests (direct memory access (DMA) requests) from the I/O device 108 or the AU 110 to the system memory 106. For example, to access the registers 140 of the I/O device 108, the registers 136 of the AU 110, and/or the AU memory 134, the CPU 102 issues one or more MMIO requests. Such MMIO requests each request access to read, write, fetch, or pre-fetch data residing at one or more virtual addresses (e.g., guest virtual addresses) which each represent at least a portion of the registers 140 of the I/O device 108, the registers 136 of the AU 110, or the AU memory 134, respectively. As another example, to access the system memory 106 without using the CPU 102, the I/O device 108, the AU 110, or both are configured to issue one or more DMA requests. Such DMA requests each request access to read, write, fetch, or pre-fetch data residing at one or more virtual addresses (e.g., device virtual addresses) which each represent at least a portion of the system memory 106. Based on receiving an MMIO request or DMA request, the IOMMU 148 is configured to translate the virtual address indicated in the MMIO or DMA request to a physical address and fulfill the request.

In variations, the processing system 100 can include any combination of the components depicted and described. For example, in at least one variation, the processing system 100 does not include one or more of the components depicted and described in relation to FIG. 1A. Additionally or alternatively, in at least one variation, the processing system 100 includes additional and/or different components from those depicted. The processing system 100 is configurable in a variety of ways with different combinations of components in accordance with the described techniques.

FIG. 1B is an example block diagram of the non-limiting example processing system 100 having a device 152 that implements indexing techniques to identify accelerator locations.

Specifically, the illustrated processing system 100 depicts a device 152 with an operating system 104 and a universal baseboard 154 with multiple accelerator units mounted thereon. Examples of device 152 include data centers, servers, and computing devices with multiple GPUs 156.

A processing system (not illustrated in FIG. 1B) runs the operating system (OS) 104 that manages the execution of applications in the device 152. For example, the OS 104 is configured to schedule the execution of tasks (e.g., instructions) for applications, allocate resources for executing application tasks, and/or provide an interface to input/output devices for the applications.

The universal baseboard 154 is a standardized motherboard within the device (e.g., server) chassis, providing electrical connections, communication pathways, and power delivery for various modules or components mounted thereon. The design of the universal baseboard 154 generally allows for easy integration of different modules (e.g., GPUs 156). This modular design allows a data center to choose the specific accelerator units (e.g., GPUs 156) that best suit its workload requirements. The modularity also provides the flexibility to add or remove units as needed and simplifies upgrades or repairs of the device 152 and the GPUs 156.

The GPUs 156 are electronic circuits (e.g., implemented as an integrated circuit) that perform various operations, including machine-learning inference. Example implementations of the GPU 156 include, but are not limited to, an IPU, NNE, NPU, VPU, FPGA, APU, and DSP. For example, the GPU 156 is a processor that reads and executes instructions (e.g., of a program) to take advantage of the learning capabilities of a machine-learning model or other AI-based techniques and the high compute powers of system-on-chip (SoC) architectures, which include AI engine(s) and other processing accelerators in some instances, to assist with the described techniques.

As illustrated, the universal baseboard 154 includes multiple GPUs 156. In the illustrated example, eight GPUs 156 (e.g., GPU 156-1, 156-2, 156-3, 156-4, 156-5, 156-6, 156-7, and 156-8) are mounted on the universal baseboard 154 in a four-by-two grid (e.g., with four rows 160 and two columns 162). The GPUs 156 are communicatively coupled (e.g., via a bus structure or any other type of interconnect enabling transfer of data between various device components described herein) to the operating system 104 and other components of the device 152.

Various physical arrangements, numbering, and nature of accelerator units are possible for the device 152 to implement the described techniques. For example, a different number (e.g., 16 or 32 units) of GPUs 156 are mounted in a similar grid array on the universal baseboard 154 in another implementation. In other implementations, the GPUs 156 are mounted in a different configuration, including in a three-dimensional (3D) grid (e.g., with a certain number of rows, columns, and layers), a 2D circular orientation, a 3D conical orientation, a 3D spherical orientation, or another 2D or 3D physical arrangement. As described above, one or more GPUs 156 are replaced by accelerators, NNEs, NPUs, APUs, IPUs, FPGAs, or similar processing units in yet other implementations.

The operating system 104 represents the physical locations of GPUs 156 via GPU indexing 158, which indicates or embeds the physical location information of each GPU 156 in its index identifier as enumerated by the OS 104 or another component of the device 152. In the illustrated configuration of GPUs 156 on the universal baseboard 154, eight GPUs are arranged in a four-by-two grid. The indexing of each GPU 156 indicates its location within the grid. For example, the index number “102” indicates the corresponding GPU is located in the first (“1xx”) row and second (“x02”) column. Accordingly, the eight GPUs in the illustrated configuration have an GPU indexing 158 of: GPU 101, GPU 102, GPU 201, GPU 202, GPU 301, GPU 302, GPU 401, and GPU 402.

The GPU indexing 158 is standardized for device 152 (or across multiple devices 152 in a particular data center or across the industry) to read the index numbers in a known or consistent coordinate system. For example, the last two digits in the illustrated index scheme provide a column 162 identifier (e.g., with the columns being in the top-to-bottom direction) and the first one or two digits provide a row 160 identifier (e.g., with the rows being in the left-to-right direction). In FIG. 1B, the GPU indexing 158 uses base ten numbering to index the GPUs 156. In other implementations, a different base numbering scheme and/or lettering scheme (e.g., base-two or base-sixteen format) is used to identify the accelerator locations. In some implementations, the numbering of each row 160 and column 162 is marked on the universal baseboard 154 to simplify identifying the GPU 156 that corresponds to a particular index identifier.

In one implementation, the two parameters corresponding to a GPU’s location are combined into a single integer by bit shifting and bit masking. For example, consider a base-16 integer (e.g., 0x0000), where the first two digits represent Y (a particular row) and the last two digits represent X (a particular column). As a result, a grid of up to 255 by 255 GPUs is represented with this indexing scheme. A GPU with an index of 0x020A is in the second row and tenth column. In this way, the indexing makes it immediately clear to a technician where the GPU is located by looking at its index without calculating or deciphering its location.

Conventional techniques enumerate the GPUs 156 in device 152 as consecutive numerical digits (e.g., starting at zero) based on their enumeration by the OS 104 or another software or firmware component of the device 152. In contrast, the described techniques provide that the GPU indexing 158 is agreed on or shared between different components of the device 152, including the operating system 104, video basic input/output systems (VBIOS) of the GPUs 156, hypervisors, and other software and firmware of the device 152. The coordinate system embedded in the GPU indexing 158 is then dynamically generated to match each GPU index identifier with the GPU’s physical location on the universal baseboard 154. In this way, the GPU indexing 158 makes it straightforward for a technician to find, repair, troubleshoot, and/or replace a specific GPU 156 mounted on the universal baseboard 154 without consulting additional resources.

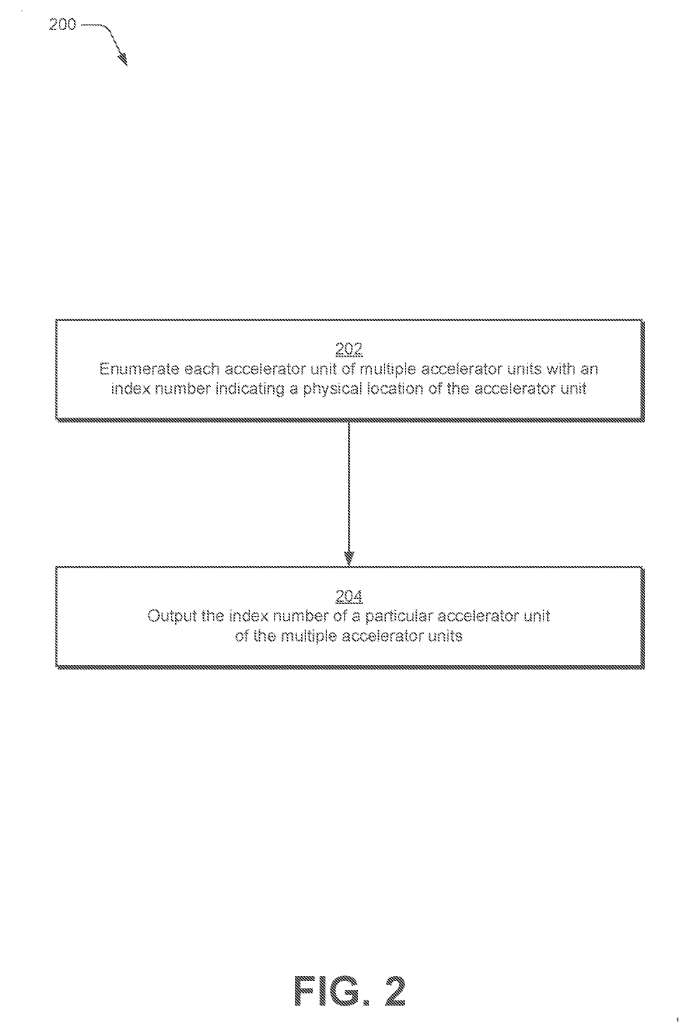

FIG. 2 is a block diagram of a non-limiting example procedure 200 that illustrates a stepwise algorithm for identifying the location of accelerator units. Procedure 200 is shown as operations (or actions) performed, but not necessarily limited to the order or combinations in which the operations are shown. Any one or more operations may be repeated, combined, or reorganized to provide other algorithms. In portions of the following discussion, reference may be made to the systems and components of FIGS. 1A and 1B by example. The procedure 200 is not limited to performance by the mentioned systems and components.

Each accelerator unit of multiple accelerator units is enumerated with an index number or index identifier that indicates the physical location of the accelerator unit within the physical configuration or layout of the multiple accelerator units (block 202). For example, the index number is generated by an indexer included as hardware circuitry, software, firmware, or a combination thereof in a BIOS or VBIOS of the accelerator units or an operating system or hypervisor of the computing system. The index number is provided in various formats, including a base-two, base-ten, or base-16 (or hexadecimal) format. In one implementation, the accelerator units are arranged in a 2D rectangular formation, and the index number indicates a vertical position (e.g., row number) and a horizontal position (e.g., column number) of each accelerator unit. In another implementation, the accelerator units are arranged in a 3D cuboid formation with the index number indicating a vertical position (e.g., row number), a horizontal position (e.g., column number), and a depth position (e.g., layer number) of each accelerator unit therein. In yet another implementation, the accelerator units are arranged in a circular formation (e.g., around a CPU) with the index number indicating an angular position (e.g., degree offset from a starting position or a number corresponding to a location on an analog clockface) or the radial distance of each accelerator unit therein.

For example, the accelerator units are GPUs, NNEs, NPUs, IPUs, APUs, FPGAs, VPUs, or DSPs. The multiple accelerator units, for example, are included in a server of multiple servers within a data center. The accelerator units are mounted on a universal baseboard in one implementation according to the OAM specification.

The index number of a particular accelerator unit of the multiple accelerator units is output (block 204). For example, a performance log identifies the index number of the particular accelerator unit to be serviced or replaced by a technician in a data center. The described index number makes it immediately clear the location of the GPU on the baseboard using a graphical representation of its location. In this way, the triage, debugging, and servicing process is improved by reducing the time to locate accelerator units. The described indexing scheme also makes it easier to notice trends in unit failures (e.g., a GPU indexed 402 repeatedly fails).

Many variations are possible based on the disclosure herein. Although features and elements are described above in particular combinations, each feature or element is usable alone without the other features and elements or in various combinations with or without other features and elements.

In one or more implementations, the methods and procedures provided herein are implemented in a computer program, software, or firmware incorporated in a non-transitory computer-readable storage medium for execution by a computer or a processor. Examples of non-transitory computer-readable storage mediums include read-only memory (ROM), random-access memory (RAM), a register, cache memory, semiconductor memory devices, magnetic media such as internal hard disks and removable disks, magneto-optical media, and optical media such as CD-ROM disks, and digital versatile disks (DVDs).

Although the systems and techniques have been described in language specific to structural features and/or methodological acts, it is to be understood that the systems and techniques defined in the appended claims are not necessarily limited to the specific features or acts described. Instead, the specific features and acts are examples of implementing the claimed subject matter.

What is claimed is:

1. A system comprising:
multiple accelerator units positioned in a physical configuration; and
indexer circuitry configured to enumerate each accelerator unit of the multiple accelerator units with an index number that indicates a physical location of the accelerator unit within the physical configuration.

2. The system of claim 1, wherein the accelerator unit comprises a graphics processing unit (GPU), neural network engine (NNE), neural processing unit (NPU), inference processing unit (IPU), accelerated processing unit (APU), vision processing unit (VPU), digital signal processor (DSP), or field-programmable gate array (FPGA).

3. The system of claim 1, wherein:
the physical configuration is a two-dimensional (2D) rectangle; and
the index number indicates a horizontal position and a vertical position of the accelerator unit within the 2D rectangle.

4. The system of claim 1, wherein:
the physical configuration is a three-dimensional (3D) cuboid; and
the index number indicates a horizontal position, a vertical position, and a depth position of the accelerator unit within the 3D cuboid.

5. The system of claim 1, wherein:
the physical configuration is a two-dimensional (2D) circle; and
the index number indicates an angular position of the accelerator unit within the 2D circle.

6. The system of claim 1, wherein the system comprises a server of multiple servers within a data center.

7. The system of claim 1, wherein the multiple accelerator units are mounted on a universal baseboard according to an Open Compute Project (OCP) Accelerator Module (OAM) specification.

8. The system of claim 7, wherein the universal baseboard includes markings corresponding to the index number of each accelerator unit.

9. The system of claim 1, wherein the indexer circuitry includes software or firmware in a basic input/output system (BIOS) of the multiple accelerator units, an operating system of the system, or a hypervisor of the system.

10. The system of claim 1, wherein the index number is provided as a value in base-two, base-ten, or base-16 format.

11. A method comprising:
enumerating, by indexer circuitry, each accelerator unit of multiple accelerator units in a computing device with an index identifier indicating a physical location of each accelerator unit within the computing device; and
outputting the index identifier of a first accelerator unit of the multiple accelerator units to be serviced.

12. The method of claim 11, wherein the computing device comprises a server.

13. The method of claim 11, wherein the index identifier is provided in a coordinate system corresponding to a physical configuration of the multiple accelerator units in the computing device.

14. The method of claim 11, wherein the multiple accelerator units are mounted on a baseboard or chassis according to a known specification.

15. The method of claim 11, wherein the indexer circuitry includes a basic input/output system (BIOS) of each accelerator unit, an operating system of the computing device, or a hypervisor of the computing device.

16. The method of claim 11, wherein the index identifier is provided as a value in base-two, base-ten, or base-16 format.

17. An accelerator unit comprising:
indexer circuitry configured to enumerate the accelerator unit with an index identifier that indicates a physical location of the accelerator unit within a physical configuration of multiple accelerator units on a baseboard.

18. The accelerator unit of claim 17, wherein the indexer circuitry includes a video basic input/output system (VBIOS) of the accelerator unit.

19. The accelerator unit of claim 17, wherein the accelerator unit comprises a graphics processing unit (GPU), neural network engine (NNE), neural processing unit (NPU), inference processing unit (IPU), accelerated processing unit (APU), vision processing unit (VPU), digital signal processor (DSP), or field-programmable gate array (FPGA).

20. The accelerator unit of claim 17, wherein the index identifier is provided in a coordinate system corresponding to the physical configuration of the multiple accelerator units in a computing device.
